(19) United States
(12) Patent Application Publication
(10) Pub. No.: US 2011/0313676 A1
(43) Pub. Date: Dec. 22, 2011

(54) Methods, Systems, and Media for Identifying Transcription Factor Binding Sites

(76) Inventors: Jonathon T. Hill, Provo, UT (US); Lori Sussel, New York, NY (US)

(21) Appl. No.: 13/118,148

(22) Filed: May 27, 2011

Related U.S. Application Data
(60) Provisional application No. 61/349,131, filed on May 27, 2010.

(51) Int. Cl. G06F 19/00

(52) U.S. Cl. 702/19

(57) ABSTRACT

Provided are systems, methods, and media that receive chromosome sequence data; select a first plurality of overlapping octamers from the chromosome sequence data; assign an enrichment score to each of the first plurality of overlapping octamers to produce a first set of enrichment scores; calculate a first average of the first set of enrichment scores; determine whether the first average is above a threshold; select a second plurality of overlapping octamers from the chromosome sequence data; assign an enrichment score to each of the second plurality of overlapping octamers to produce a second set of enrichment scores; calculate a second average of the second set of enrichment scores; determines whether the second average is above the threshold; and output data that indicates that a transcription factor binding site has been identified in connection with at least one of the first plurality of octamers and the second plurality of octamers.

### CROSS REFERENCE TO RELATED APPLICATION

This application claims the benefit of U.S. Provisional Patent Application No. 61/349,131, filed May 27, 2010, which is hereby incorporated by reference herein in its entirety.

### STATEMENT REGARDING FEDERALLY SPONSORED RESEARCH

This invention was made with government support under Grants U01 DK072504 and RO1 DK082590 awarded by the National Institute of Health. The government has certain rights in the invention.

### TECHNICAL FIELD

The disclosed subject matter relates to methods, systems, and media for identifying transcription factor binding sites.

### BACKGROUND

The dynamic process of gene regulation is essential for embryonic development and cellular function. Gene regulation is primarily mediated by the combinatorial effects of transcription factors interacting with cis-regulatory elements such as promoters and enhancers. Therefore, accurate identification of transcription factor binding sites within the genome is necessary to understand a wide range of cellular processes from cell differentiation to homeostasis to cancer. However, identifying these sites within the genome remains a complex biological and computational question.

One of the challenges in predicting transcription factor binding sites is that identification of the strongest binding sequence, or consensus site, is not sufficient. Research analyzing genome wide transcription factor occupancy has shown that low affinity binding sites are also significantly occupied in both yeast and drosophila. Furthermore, transcription factors from the same family have been shown to bind identical high affinity sites, but distinct low affinity sites. Therefore, identification of both high and low affinity sites will aid in fully understanding transcription factor specificity within the genome.

Nkx2.2 is a homeodomain transcription factor expressed in the ventral neural tube and the pancreas during development. A consensus sequence (T(t/c)AAGT(a/g)(c/g)TT) has been identified by SELEX and a corresponding position weight matrix (PWM) was generated and deposited in the TRANSFAC database. However, the predictive power of this PWM is low. More recently, a PWM for Nkx2.2 was generated using protein binding microarray technology. Protein Binding Microarrays use a mathematically constructed set of oligos to quantitatively measure protein-DNA binding for all possible octamers.

The identification of transcription factor binding sites is an important biological question. To date, the majority of methods to detect these sites have focused on creating statistical models, such as position weight matrices, of transcription factor specificities. However, these models are limited due to the fact that they must make generalized assumptions about transcription factor binding properties that are not completely understood. Conversely, recent technologies have been developed such as ChIP-seq to look at genomic transcription factor occupancy. However, these technologies are technically difficult and limited by the lack of high quality antibodies for many transcription factors.

Accordingly, new mechanisms for identifying transcription factor binding sites are needed.

### SUMMARY

Methods, systems, and media for identifying transcription factor binding sites in accordance with some embodiments are provided. In accordance with some embodiments, systems for identifying transcription factor binding sites are provided, the systems comprising at least one processor that: receives chromosome sequence data; selects a first plurality of overlapping octamers from the chromosome sequence data; assigns an enrichment score to each of the first plurality of overlapping octamers to produce a first set of enrichment scores; calculates a first average of the first set of enrichment scores; determines whether the first average is above a threshold; selects a second plurality of overlapping octamers from the chromosome sequence data; assigns an enrichment score to each of the second plurality of overlapping octamers to produce a second set of enrichment scores; calculates a second average of the second set of enrichment scores; determines whether the second average is above the threshold; and outputs data that indicates that a transcription factor binding site has been identified in connection with at least one of the first plurality of octamers and the second plurality of octamers.

In accordance with some embodiments, methods for identifying transcription factor binding sites are provided, the methods comprising: receiving chromosome sequence data; selecting a first plurality of overlapping octamers from the chromosome sequence data; assigning an enrichment score to each of the first plurality of overlapping octamers to produce a first set of enrichment scores; calculating a first average of the first set of enrichment scores; determining whether the first average is above a threshold; selecting a second plurality of overlapping octamers from the chromosome sequence data; assigning an enrichment score to each of the second plurality of overlapping octamers to produce a second set of enrichment scores; calculating a second average of the second set of enrichment scores; determining whether the second average is above the threshold; and outputting data that indicates that a transcription factor binding site has been identified in connection with at least one of the first plurality of octamers and the second plurality of octamers.

In accordance with some embodiments, computer readable media containing computer-executable instructions that, when executed by a processor, cause the processor to perform a method for identifying transcription factor binding sites are provided, the method comprising: receiving chromosome sequence data; selecting a first plurality of overlapping octamers from the chromosome sequence data; assigning an enrichment score to each of the first plurality of overlapping octamers to produce a first set of enrichment scores; calculating a first average of the first set of enrichment scores; determining whether the first average is above a threshold; selecting a second plurality of overlapping octamers from the chromosome sequence data; assigning an enrichment score to each of the second plurality of overlapping octamers to produce a second set of enrichment scores; calculating a second average of the second set of enrichment scores; determining whether the second average is above the threshold; and outputting data that indicates that a transcription factor binding site has been identified in connection with at least one of the first plurality of octamers and the second plurality of octamers.

### BRIEF DESCRIPTION OF THE DRAWINGS

FIG. 1A shows an enrichment score (E-score) distribution table of Nkx2.2 in accordance with some embodiments.

FIG. 1B is a histogram showing the number of occurrences of each possible base in the first position for all possible E-scores in accordance with some embodiments.

FIG. 1C shows the results of an Electrophoretic Mobility Shift Assay (EMSA) experiment performed in accordance with some embodiments.

FIG. 2A is a flowchart showing a PBM-mapping process in accordance with some embodiments.

FIG. 2B shows the results of another EMSA experiment performed in accordance with some embodiments.

FIG. 2C shows the results of a Chromatin Immunoprecipitation (ChIP) experiment performed in accordance with some embodiments.

FIGS. 3A-3C show three graphs of the relative binding affinity versus prediction scores for PBM-mapping, TRANSFAC, and PBM-PWM in accordance with some embodiments.

FIG. 4A shows a schematic representation of the NeuroD promoter in accordance with some embodiments.

FIG. 4B shows the results of yet another EMSA experiment performed in accordance with some embodiments.

FIGS. 5A-5F are graphs showing relative binding affinity versus prediction score from PBM-mapping for groups of one, three, five, seven, and eight octamers in accordance with some embodiments.

### DETAILED DESCRIPTION

As is known in the art, the transcription factor Nkx2.2 binds a 10 base-pair sequence that was thought to contain an invariable “AAGT” core sequence. In accordance with some embodiments, a mechanism for identifying an alternative core sequence for a transcription factor (such as Nkx2.2) is provided. Using this mechanism, an alternative low-affinity core sequence with a wobble in the first position that contains “GAGT” has been identified.

Berger M F, et al., “Variation in homeodomain DNA binding revealed by high-resolution analysis of sequence preferences,” Cell 133(7):1266-1276, 2008, which is hereby incorporated by reference herein in its entirety, published a protein binding microarray (PBM) analyzing the binding affinity of the Nkx2.2 homeodomain transcription factor. PBMs generate an enrichment score (E-score) with a range from −0.5 to 0.5 for every possible eight-base combination based on the relative intensity readouts from the microarray data.

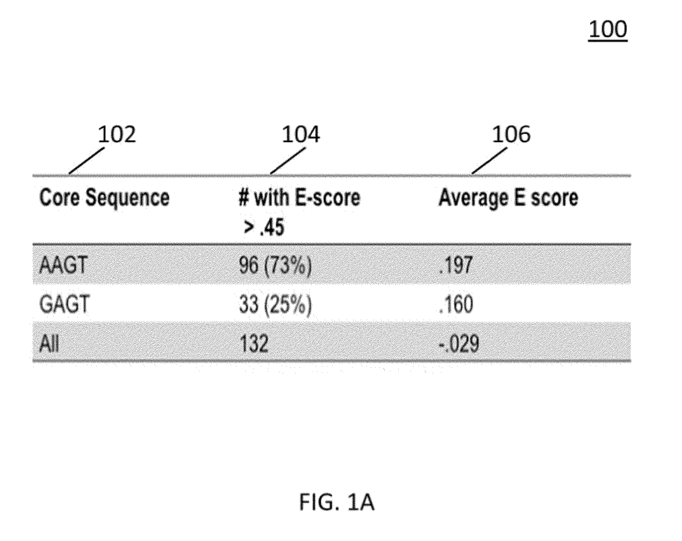

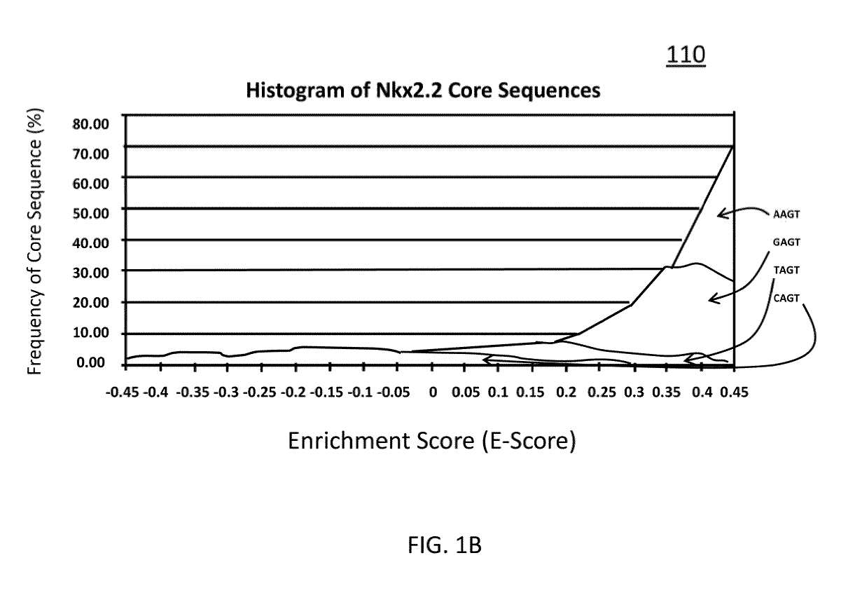

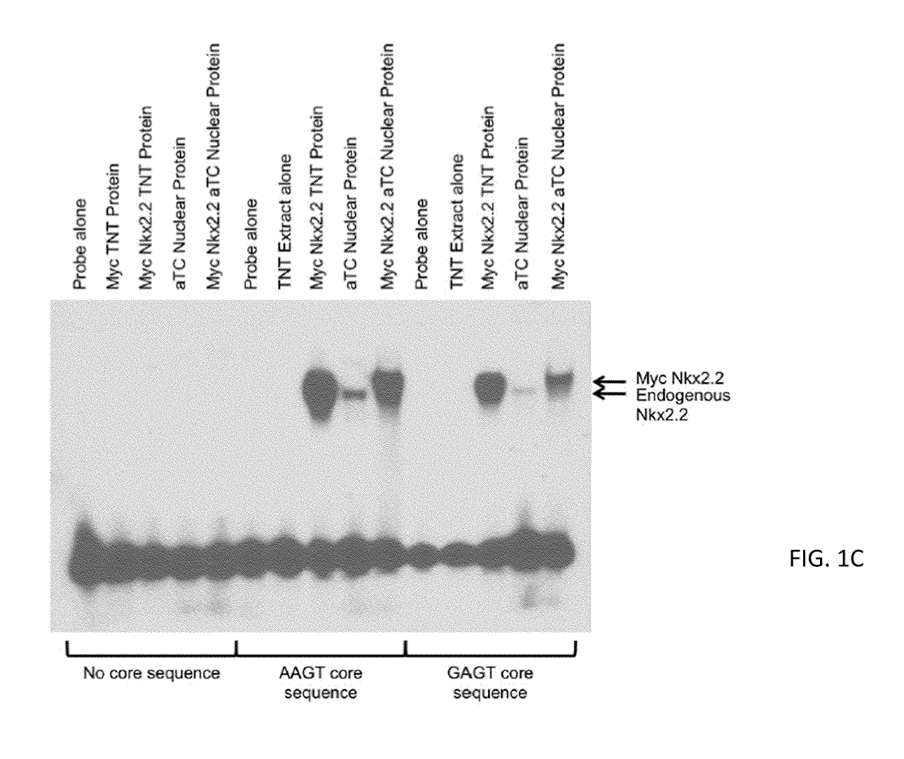

FIG. 1A shows an E-score distribution table of octamers on Nkx2.2. In the rows of the table, octamers are divided into AAGT containing octamers, GAGT containing octamers, and all octamers as indicated in left column 102. The number of octamers in each group with an E-score above 0.45 is shown in middle column 104. The average of the E-scores from all octamers in each group is shown in right column 106.

In accordance with some embodiments, a mechanism for identifying an alternative core sequence for a transcription factor can operate as follows: First, all octamers with an E-score greater than 0.45 can be selected. As shown in the last row of column 104 of FIG. 1A, 132 octamers were selected for Nkx2.2. In some embodiments, any other suitable threshold value (i.e., other than 0.45) can be used. Of the selected octamers, the octamers containing a known core sequence can be removed. For example, in embodiments in which the transcription factor is Nkx2.2, 96 (73%) octamers containing the canonical “AAGT” core sequence or its reverse compliment “ACTT” were removed. Any other suitable octamers can be removed or these octamers can be retained in some embodiments. An alternative core sequence can then be identified in the remaining octamers. For example, in embodiments in which the transcription factor is Nkx2.2, of the remaining 36 octamers, 33 (25% of the total) octamers had an alternative sequence “GAGT.” Two of the sequences originally classified as AAGT-containing octamers also had “GAGT” (AAGTGAGT and GAGTAAGT) while three octamers did not contain either core sequence. Finally, the average E-score for octamers containing AAGT, octamers containing GAGT, and all possible octamers can next be calculated to confirm that the average E-scores for the primary and alternative core sequences are significantly larger than the mean for all possible octamers. For example, in embodiments in which the transcription factor is Nkx2.2, AAGT and GAGT containing octamers had mean E-score values of 0.197 and 0.160, respectively, while all possible octamers had a mean E-score of only −0.029, as shown in column 106 of FIG. 1A.

As can be seen, the two identified core sequence motifs differ only in the first position. In order to determine whether significant enrichment can be seen with the other two possible first bases (e.g., TAGT and CAGT), a histogram 110 of the number of occurrences of each possible base in the first position (i.e., AAGT, GAGT, TAGT and CAGT) for all E-scores can be plotted as shown in FIG. 1B. Each point in this histogram represents the percentage of total sites within a 0.10 bin that contains the given core sequence. As can be seen, there is a significant enrichment of only the AAGT and GAGT core sequences.

In order to experimentally test the alternative GAGT binding site, Electrophoretic Mobility Shift Assay (EMSA) experiments were performed as shown in FIG. 1C.

The EMSA experiments were performed as follows: First, in vitro synthesized Nkx2.2 protein was made using the TNT Coupled Reticulolysate System (available from Promega Corporation). Probes were next prepared containing each of the predicted core sequences analyzed or a deleted core sequence. The sequences of each of the probes are listed in Table 1 of Appendix I.

The probe containing the Nkx2.2 consensus sequence was prepared as described in Watada H, Mirmira R G, Kalamaras J, & German M S, “Intramolecular control of transcriptional activity by the NK2-specific domain in NK-2 homeodomain proteins,” Proc Natl Acad Sci USA, 97(17):9443-9448, 2000, and Anderson K R, et al., “Cooperative transcriptional regulation of the essential pancreatic islet gene NeuroD1 (beta2) by Nkx2.2 and neurogenin 3,” J Biol Chem 284(45):31236-31248, 2009, which are hereby incorporated by reference herein in their entireties.

Binding of each of the probes to the in vitro synthesized Nkx2.2 (Myc-Nkx2.2 TNT Protein) or alphaTC 1 nuclear extract with or without transfected Myc-Nkx2.2 was measured as follows.

Probes were labeled by filling in 5′ overhangs with ³²P-dCTP. The binding buffer included 100 mM Tris HCl pH 7.5, 500 mM NaCl, 5 mM EDTA, 10 mM MgCl2, 40% glycerol, 5 mM DTT, 10×BSA, and 0.1 μg/μl of polydIdC. Binding reactions were incubated on ice for 45 minutes with 5 μl of in vitro synthesized protein and 25,000 CPMs, corresponding to approximately 1 fmol, of labeled probe. Samples were run on 5% non-denaturing polyacrylamide gels at 180 V for 1.5 hours in 1×TGE buffer (250 mM Tris base, 1.9 M glycine, and 10 mM EDTA).

Bands were quantified using the integrated mean of a fixed window for each of the shifts using Photoshop Extended CS3 (available from Adobe Systems Inc.). Values were normalized to total probe (shifted probe+free probe).

Binding of each probe was next compared to both the original consensus probe and a probe with a deleted core sequence. The GAGT containing probe showed significant binding with in vitro translated Nkx2.2 (TNT Nkx2.2) or nuclear extract from alphaTC1 cells with or without transfected Nkx2.2, although binding was weaker than the AAGT containing probe.

Taken together, these experiments show that GAGT represents an alternative core sequence for Nkx2.2 binding sites, although its relative binding affinity is lower than the canonical AAGT core sequence.

In accordance with some embodiments, protein binding microarray data can be mapped directly to the genome to identify putative binding sites, such as Nkx2.2 binding sites.

The enrichment score (E-score) generated from the protein binding microarray can represent a semi-quantitative estimate of transcription factor binding affinity. In accordance with some embodiments, the E-score for each octamer can be mapped to the genome to predict Nkx2.2 binding sites. This mapping can be referred to a PBM-mapping.

In accordance with some embodiments, single octamers with an E-score greater than 0.4 (or any other suitable threshold) can be mapped.

In accordance with other embodiments, a moving average of seven (or any other suitable number) of octamers can be mapped to predict binding affinity with greater accuracy. Sequences with a moving average greater than a given threshold can then be deposited into a database and can be output to a display if desired. The threshold can be set to approximately 0.37 (or any other suitable value).

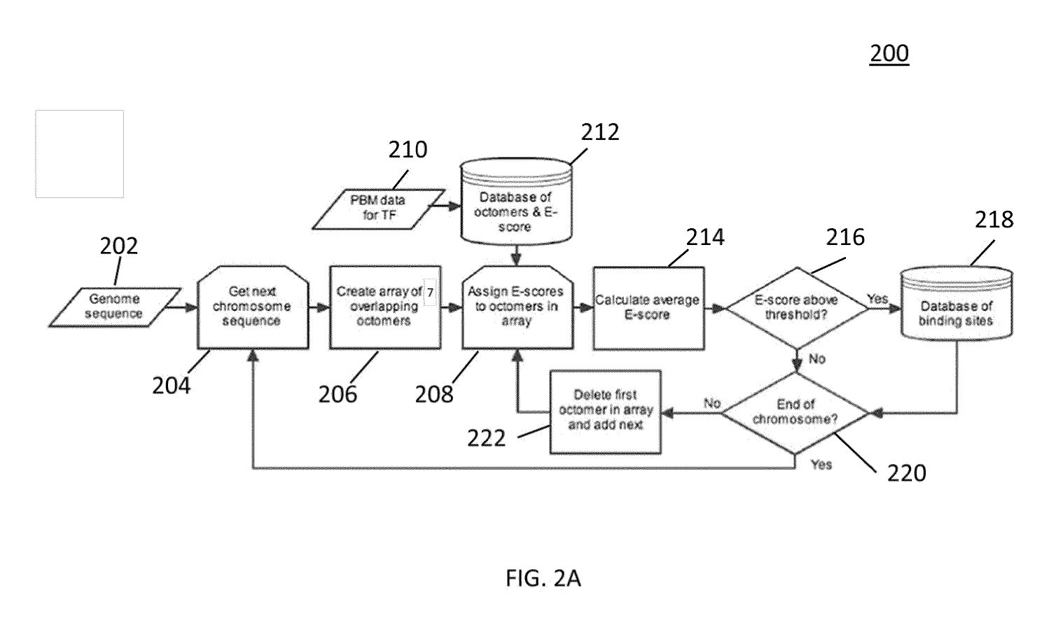

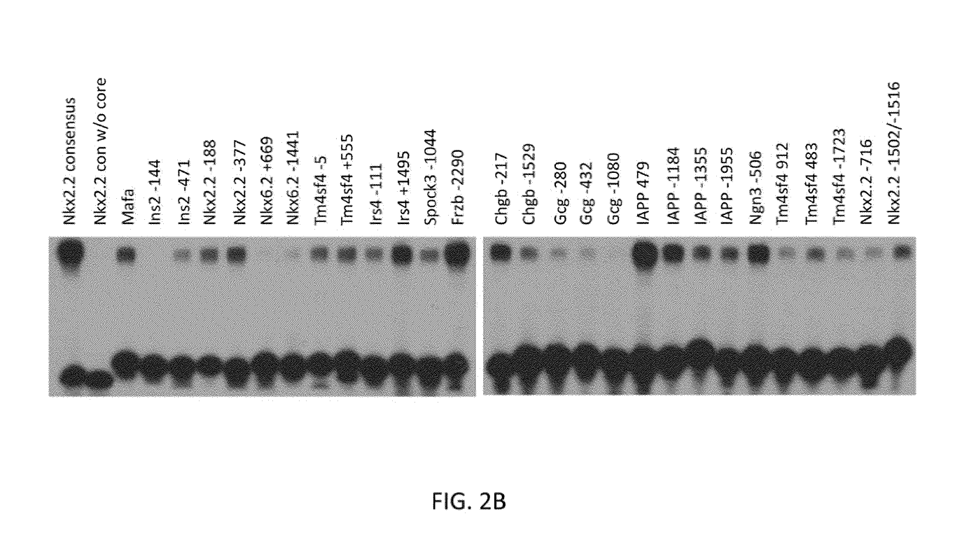

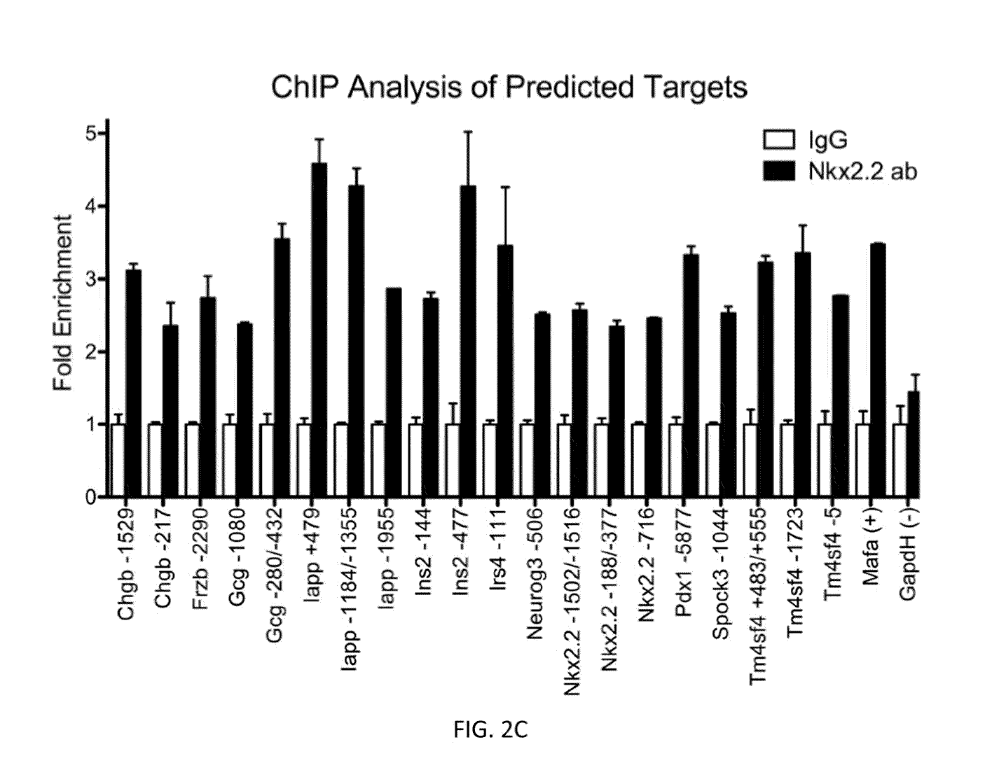

A PBM-mapping process 200 that can be used in accordance with some embodiments is illustrated in FIG. 2A. As shown, PBM data for a given transcription factor can be received at 210 and provided to a database of octamers and E-scores 212. A genome sequence can also be received at 202. Process 200 can then get a first (or the next) chromosome sequence of the genome at 204. An array of seven overlapping octamers can next be formed at 206. At 208, E-scores can then be assigned to the octamers in the array based on the data in database 212. Process 200 can then calculate an average E-score for the array of seven octamers at 214. It can next be determined at 216 if the average E-score is above a given threshold (such as 0.37 or any other suitable value). If the average E-score is above the given threshold, a database 218 of binding sites can be updated with the array data, the average E-score, and/or any other suitable data. After database 218 is updated, or if it is determined at 216 that the average E-score is not above the given threshold, process 200 can then determine if the end of the chromosome has been reached at 220. If it has not, then process 200 can, at 222, delete the first octamer in the array, shift the contents of the array one position toward the former position of the first octamer, add the next octamer in the last position of the array, and loop back to 208. Otherwise, if it is determined at 220 that the end of the chromosome has been reached, then process 200 can loop back to 204 to get the next chromosome sequence.

Using this technique, complete analysis of the genome resulted in 3×10̂6 predicted sites, which falls within range of the expected number of transcription factor binding sites expected in the genome. In order to investigate sites that are most likely to be biologically relevant, a search for sites was limited to bound promoters (from 2.5 kb upstream to 1 kb downstream) of genes with expression levels significantly changed (e.g., more than two-fold) in Nkx2.2 null mice at e12.5 or e13.5 and one hundred and eleven novel Nkx2.2 binding site found.

The results of sites within these promoters can be found in Table 2 of Appendix II. Binding sites were found in seven out of eight genes with increased expression and 24 out of 27 genes with decreased expression in the Nkx2.2 null pancreas. GAGT containing sites were highly represented in the predicted sites—confirming the ability of the technique to predict alternate sites. Twenty three sites, including six GAGT containing sites, were confirmed using EMSA analysis as shown in FIG. 2B, and 24 sites were confirmed using Chromatin Immunoprecipitation (ChIP) as shown in FIG. 2C.

EMSA analysis of selected predicted sites was performed as described above except that probes spanning approximately 50-60 base pairs surrounding the predicted site were incubated with in vitro synthesized Nkx2.2, and the Nkx2.2 consensus probe and the consensus probe with the core sequence deleted were used as positive and negative controls, respectively.

Confirmation of in vivo promoter occupancy at predicted sites by ChIP was performed using the Active Motif ChIP IT Express kit (available from Active Motif, Inc.). BetaTC6 cells were used for chromatin input and Nkx2.2 mouse monoclonal antibody was used for precipitations. BetaTC6 cells were grown in DMEM supplemented with 15% FBS. Approximately 1.5×10̂7 cells were crosslinked in 1% paraformaldehyde for five minutes at room temperature. Chromatin was then extracted and sheared by sonication using a Diagnode BioRuptor (8 min-30 sec ON/OFF) resulting in chromatin fragments from 200-800 base pairs long. The sheared chromatin was divided into six reactions and run independently. Pulldowns were done with 3 μg mouse anti-Nkx2.2 monoclonal antibody (available from Developmental Studies Hybridoma Bank). Enrichment is shown as fold change over IgG. Normal mouse IgG (available from Millipore Corporation) was used as a negative control. Occupancy of the predicted sites was tested by Sybr-Green qPCR (primers are listed in Table 3 of Appendix III).

All predicted sites were significantly increased over the IgG control. The housekeeping gene GapdH was used as a negative control and was not significantly enriched. Nkx6.2 −1441, nkx6.2 +669, Irs4 +1495 and Tm4sf4 +912 were not tested in ChIP for technical reasons.

Tested sites were randomly selected from putative sites in bound promoter regions. In addition to the randomly selected sites, the following sites were also included: a site predicted by the PBM-mapping mechanism described herein that is located in the Region IV enhancer of the Pdx1 promoter, an additional Irs4 site downstream of the bound region (Irs4 +1495), and a previously published Nkx2.2 binding site in the insulin promoter that was the only published site not predicted the PBM-mapping mechanism described herein.

Of the 28 sites tested by EMSA, only the insulin promoter site, the Nkx6.2 +669 site, and the glucagon −1080 site did not show detectable binding. Glucagon −1080 and Nkx6.2 +669 had an average E-score of 0.347 and 0.364, respectively, and represented the lowest scores of any predicted site tested. The Ins2 −144 site was below an original threshold with an average E-score of 0.233.

In order to test whether the E-score is correlated with relative Nkx2.2 binding affinity, the relative binding affinity of Nkx2.2 binding in the EMSA experiments was quantified and graphed against the TRANSFAC PWM score, the PBM seed and wobble matrix score, and the E-score. The TRANSFAC PWM was developed from alignment of 23 sequences enriched using SELEX experiments. The PBM-PWM was based on microarray experiments, which provide data for all possible octamers. Numerous statistical corrections to the PWM model were not part of this study.

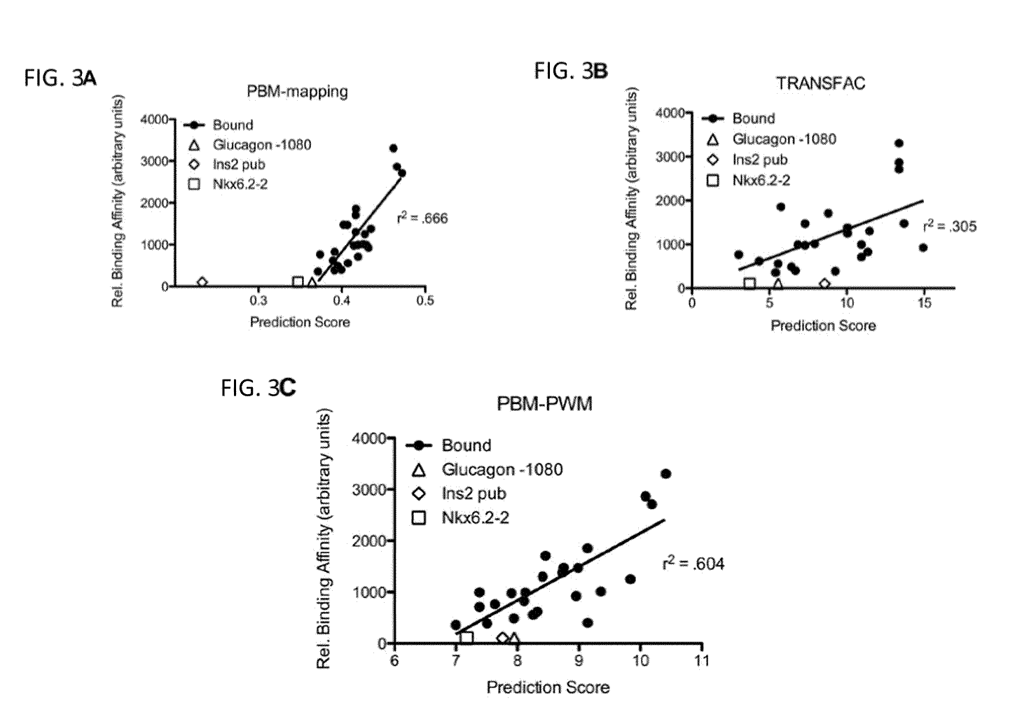

As shown in FIGS. 3A-3C, the highest score obtained from the EMSA probe was compared to relative binding affinity calculated from the EMSA shown in FIG. 2B. Probes with more than one predicted site (Spk3 and Nkx2.2 −1503) were excluded. Scores from probes that were not bound in the EMSA (Gcg −1080, Nkx6.2 +669, and Ins2 −144) were plotted along the X-axis and not used for r-squared calculation. FIG. 3A uses the average E-score from seven overlapping octamers from PBM-mapping, FIG. 3B uses the average log-odds from TRANSFAC-PWM, and FIG. 3C uses the average Seed and Wobble matrix score from PBM-PWM.

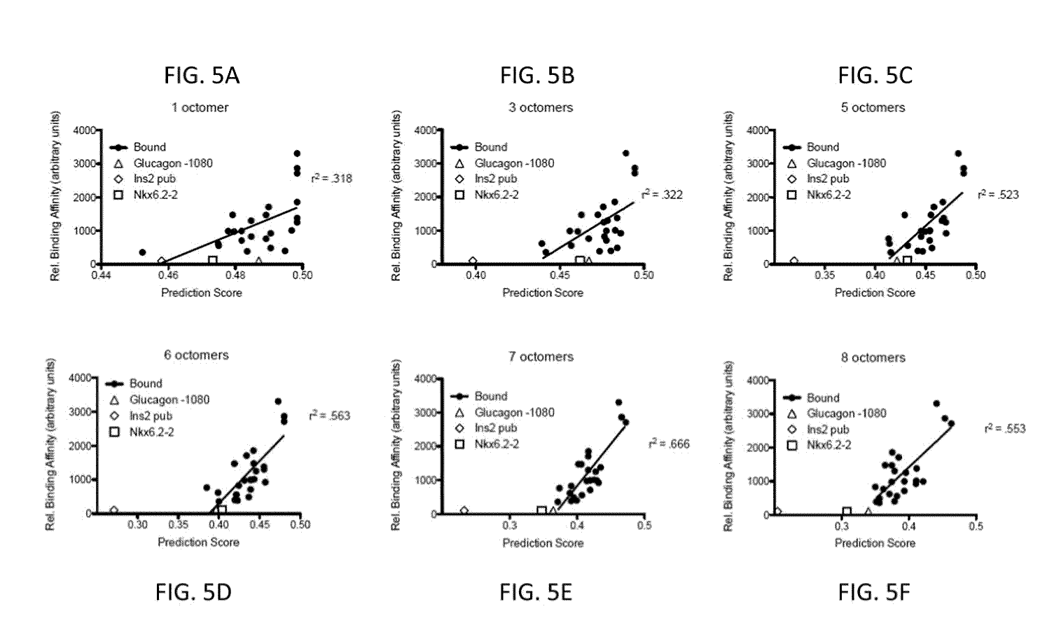

Single E-scores for the highest octamer and averages of three, five, six, seven, and eight octamer were tested as shown in FIGS. 5A, 5B, 5C, 5D, 5E, and 5F, respectively. The average of seven overlapping scores showed the highest correlation with relative binding affinity (r-squared=0.666) and outperformed both the TRANSFAC PWM score (r-squared=0.305) and the PBM seed and wobble matrix score (r-squared=0.604) as can be seen from FIGS. 3A-3C. Using a larger window of overlapping octamers resulted in a decrease in accuracy. Taken together, these experiments show that PBM-mapping represents a highly accurate prediction method to find genome wide binding sites.

Although the above-described mechanism for determining transcription factor binding sites has been illustrated for Nkx2.2, this mechanism can additionally or alternatively be applied to other transcription factor binding sites to create composite transcription factor binding site maps across the entire genome. Generation of such a map can greatly aid work to identify cis-regulatory elements and understand gene regulation. PBM data is available for at least 391 non-redundant proteins from several species, as described in Newburger D E & Bulyk M L, “UniPROBE: an online database of protein binding microarray data on protein-DNA interactions,” Nucleic Acids Res 37(Database issue):D77-82, 2009, which is hereby incorporated by reference herein in its entirety. However, adjustments to the mechanism may need to be made to account for different profiles of different classes of proteins.

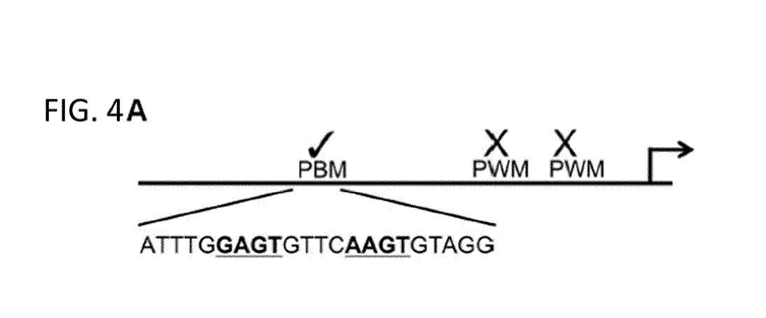

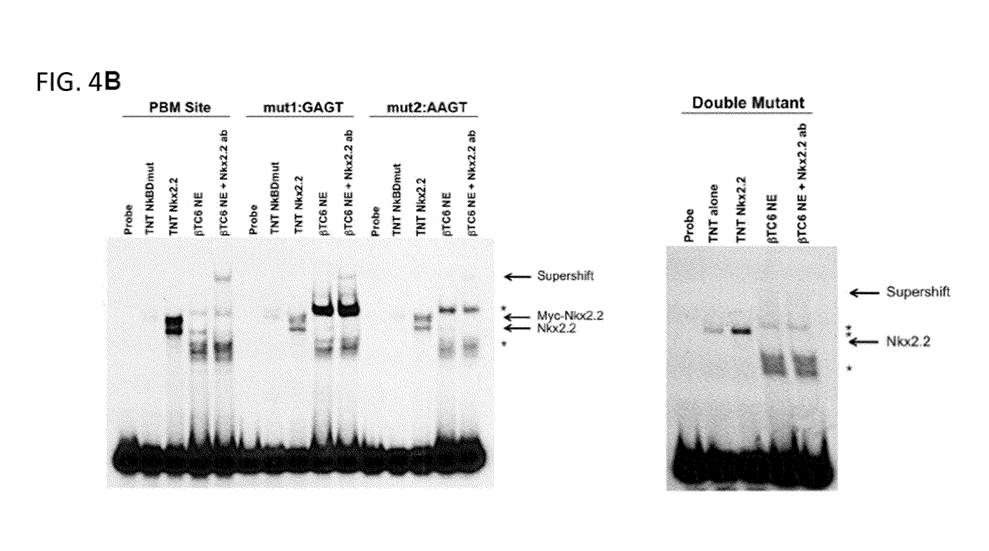

Although there is overlap between PWM based predictions and PBM mapping, two examples of promoters where the predictions are significantly different have been identified: NeuroD and Insulin. The functional control of the NeuroD promoter by Nkx2.2 is described in Anderson KR, et al., “Cooperative transcriptional regulation of the essential pancreatic islet gene NeuroD1 (beta2) by Nkx2.2 and neurogenin 3,” J Biol Chem 284(45):31236-31248, 2009, which is hereby incorporated by reference herein in its entirety. In the NeuroD promoter, the TRANSFAC-PWM for Nkx2.2 predicted two sites while PBM mapping predicted a novel site upstream of the two TRANSFAC predicted sites that were not bound in vitro or in vivo as illustrated in FIG. 4A. However, EMSA analysis confirmed binding to the PBM mapping predicted site and not to the two TRANSFAC predicted sites as shown in FIG. 4B.

As shown in FIG. 4B, EMSA analysis showed binding through both core sites, AAGT and GAGT. In this analysis, wildtype, AAGT mutant, GAGT mutant, and double mutant probes were incubated with in vitro translated Nkx2.2 or BetaTC6 nuclear extract. Supershifts were done using the monoclonal Nkx2.2 antibody.

The PBM mapping site is unique because it is predicted to consist of two adjacent binding sites separated by four base pairs as illustrated in the schematic representation of the NeuroD promoter shown in FIG. 4A. One binding site contains a canonical AAGT core sequence while the other has the GAGT core sequence identified as described above. However, EMSA experiments did not show dimerization of Nkx2.2 on the promoter. Mutation of each individual core sequence showed a reduction in binding and both sites must be mutated to completely ablate Nkx2.2 binding as shown in FIG. 4B. Therefore, both sites contribute to Nkx2.2 binding, but dimer formation is prevented, possibly by steric hinderence. This may represent a unique mechanism to increase transcription factor occupancy on the promoter.

An Nkx2.2 binding site in the insulin promoter (Ins2 −144) was previously published in Watada H, Mirmira R G, Kalamaras J, & German M S, “Intramolecular control of transcriptional activity by the NK2-specific domain in NK-2 homeodomain proteins,” Proc Natl Acad Sci USA, 97(17):9443-9448, 2000, which is hereby incorporated by reference herein in its entirety. This site is the only published Nkx2.2 binding site not predicted by the process illustrated in FIG. 2A and described herein, but this site is predicted by the TRANSFAC PWM and the PBM seed and wobble matrix. Attempts to confirm Nkx2.2 binding to this site using EMSA as shown in FIG. 2C were unsuccessful. PBM mapping predicted a site 328 bases upstream of the previously published site (Ins2 −477) and was confirmed by EMSA as also shown in FIG. 2C. ChIP analysis showed Nkx2.2 occupancy with primers for both the published and our predicted site, although occupancy was stronger on the PBM-mapping predicted site as shown in FIG. 2D. However, the ChIP results are unable to completely distinguish between occupancy of both sites because of their close proximity. It is possible that Nkx2.2 could bind this site through cooperative binding with cofactors that would not have been seen in previous experiments. Therefore, an additional EMSA analysis using BetaTC6 nuclear extract was performed. In this subsequent analysis, Nkx2.2 containing complexes formed on both sites, but in vitro translated Nkx2.2 only bound to the upstream site. Therefore, it appears that Nkx2.2 may be stabilized on the Ins2 −144 site by interacting factors.

Insulin expression is lost in the Nkx2.2 null mouse. However, mutation of the Ins2 −144 site resulted in a paradoxical increase in insulin expression. Therefore, luciferase assays were performed to assess Nkx2.2 function through the upstream Nkx2.2 binding site. Luciferase constructs were created to contain the 586 bases upstream of the Ins2 promoter.

The insulin promoter from −585 to +2 was cloned into the pGL4.17 luciferase plasmid (available from Promega Corporation). Mutagenesis of the previously published and predicted Nkx2.2 binding sites was done using the Quickchange II mutagnesis kit (available from Agilent Technologies Inc., formerly Stratagene) with the following primers and their respective reverse compliment sequence:

GGAGGAGGGACCATTGCCTTGCTGCCTGAATTC (Ins2 −144) and GACCTAGCACCAGGGGTTTGGAAACTGCAGC (Ins2 −477). A ratio of 10:1 (500 ng/50 ng) of pGL4:ins2 promoter/pRL-null plasmids were transfected using Fugene 6 transfection reagent (available from F. Hoffmann-La Roche Ltd.) into 5×10̂5 betaTC6 cells. After 48 hours, cells were harvested and assayed for luciferase activity using the dual luciferase assay kit (available from Promega Corporation). At least three independent experiments were performed in triplicate and the unpaired student t-test was used to measure significance of changes between sample conditions.

Basal activity of the promoter was very high in BetaTC6 cells. Mutation of the upstream Nkx2.2 binding site resulted in a 50% reduction in activity, indicating that Nkx2.2 increases the rate of insulin production, but is not necessary for insulin expression. Mutation of the downstream site also resulted in a decrease in luciferase levels, contrary to what was previously published. These experiments show that Nkx2.2 activates the insulin promoter through both binding sites, but binds more strongly to the Ins2 −477 site.

In accordance with some embodiments, the techniques described herein can be implemented at least in part in one or more computer systems. These computer systems can be any of a general purpose device such as a computer or a special purpose device such as a client, a server, etc. Any of these general or special purpose devices can include any suitable components such as a processor (which can be a microprocessor, digital signal processor, a controller, etc.), memory, communication interfaces, display controllers, input devices, etc.

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention. For example, in some embodiments, rather than operating on octamers (which include 8 base pairs), a suitable portion of a DNA strand including any suitable number of base pairs (e.g., 10) can be used. Features of the disclosed embodiments can be combined and rearranged in various ways.

APPENDIX I
Table 1

| Probe | Sequence |
|---|---|
| Chgb −1529 Forward | GAACAAACAC AGGGTGACTC ATTGAAGTGT GATGCATGGC TAAAAGCAGA |
| Chgb −1529 Reverse | AGTTCTGCTT TTAGCCATGC ATCACACTTC AATGAGTCAC CCTGTGTTTG |
| Chgb −217 Forward | TGAGGTTAAA AGAGAGAGAG AATTTTGAAG TGTATCCTTT GGC |
| Chgb −217 Reverse | AGGCCAAAGG ATACACTTCA AAATTCTCTC TCTCTTTTAA CC |
| Frzb −2290 Forward | AGTCCAAATA TCTTAAGGAG ATAAACCACT TGAGAGGAGA CTTAATTC |
| Frzb −2290 Reverse | TTGAGAATTA AGTCTCCTCT CAAGTGGTTT ATCTCCTTAA GATATTTGG |
| Gcg −1080 Forward | AGACCATTGA AACAACTGGA GGAGTACTCT GACTGAACTT AATTCTTCAT |
| Gcg −1080 Reverse | AGAATGAAGA ATTAAGTTCA GTCAGAGTAC TCCTCCAGTT GTTTCAATGG |
| Gcg −280 Forward | ACGAAAAACT GCTAAAGTTC TCTCAAGTGA ATTTTGACGT CAAATGAGCC TAG |
| Gcg −280 Reverse | AGACTAGGCT CATTTGACGT CAAAATTCAC TTGAGAGAAC TTTAGCAGTT TTT |
| Gcg −432 Forward | AGTACACACA TATCAATAAC CCACTCATCC ACATTGTATG GAATAAATTT GTAT |
| Gcg −432 Reverse | AGAATACAAA TTTATTCCAT ACAATGTGGA TGAGTGGGTT ATTGATATGT GTGT |
| Iapp −1184 Forward | AGTGTAAAAA ATAAATTAAT TTTAAAAAAA ACACTTAAAC GTGAACACAT |
| Iapp −1184 Reverse | TGTATGTGTT CACGTTTAAG TGTTTTTTTT AAAATTAATT TATTTTTTAC |
| Iapp −1355 Forward | TGTCCTCAGG CCGCTACATA AAGGCACTCA AGAGACTGGA GGCCCCAGGG AGTTTGGAGG |
| Iapp −1355 reverse | TGACCTCCAA ACTCCCTGGG GCCTCCAGTC TCTTGAGTGC CTTTATGTAG CGGCCTGAGG |
| Iapp −1955 Forward | GTTAAGCTGG TATGGCTAGT TAAGTGGTTA TAGCTGACAT ATAATGTCT |
| Iapp −1955 Reverse | TGAAGACATT ATATGTCAGC TATAACCACT TAACTAGCCA TACCAGCTT |
| Iapp +479 Forward | TGTCCTCCTC ATCCTCTCTG TGGCACTGAA CCACTTGAGA GCTACACCTG |
| Iapp +479 Reverse | TGACAGGTGT AGCTCTCAAG TGGTTCAGTG CCACAGAGAG GATGAGGAGG |
| Ins −144 Forward | TGCTTTCTGC AGACCTAGCA CCAGGCAAGT GTTTGGAAAC TGCAGCT |
| Ins −144 reverse | CTGAAGCTGC AGTTTCCAAA CACTTGCCTG GTGCTAGGTC TGCAGAA |
| Ins −471 forward | AAGCAGAACT CAGGCAGCAA GGTACTTAAT GGTCCCTCCT TCTCCATC |
| Ins −471 Reverse | AGAGATGGAG AAGGAGGGAC CATTAAGTAC CTTGCTGCCT GAGTTCT |
| Irs4 −111 Forward | CCGCCTAGGC CCGCGTCCCC GCCCACTTCA CTGGGCTCAA GGCAGTGG |
| lrs4 −111 reverse | TGCCCACTGC CTTGAGCCCA GTGAAGTGGG CGGGGACGCG GGCCTAGG |
| Irs4 +1495 Forward | AGCCCTGGCT ACTGGAACCT TGGCCACTTG AGCCCCGTCC ACCTCCTGAG CCC |
| Irs4 +1495 reverse | CCGGGGCTCA GGAGGTGGAC GGGGCTCAAG TGGCCAAGGT TCCAGTAGCC AGG |
| Mafa Forward | TGTAACCAGG AGGCAGCCCC TCCAGCAAGC ACTTCAGTGT GCTCAGTGGG |
| Mafa reverse | AACAGCCCCA CTGAGCACAC TGAAGTGCTT GCTGGAGGGG CTGCCTCCTG G |
| Ngn3 −506 Forward | CGCTCCTCCC AGCTGCCAGC CAAGAAGACA CTTGACTCCT TGATCGCTGG T |
| Ngn3 −506 Reverse | TGAACCAGCG ATCAAGGAGT CAAGTGTCTT CTTGGCTGGC AGCTGGGAGG A |
| Nkx2.2 −1502 Forward | GCTGCAAGTT TGCTACATAC CACTTGTTCG CCCCACTTAA CATCAGGAGT GGGCTT |
| Nkx2.2 −1502 Reverse | GCTAAGCCCA CTCCTGATGT TAAGTGGGGC GAACAAGTGG TATGTAGCAA ACTTGC |
| Nkx2.2 −188 Forward | CGCGTCGCTC TCGAGTCCAC ACACTTGAAA AGAGCCGTTT TAACAAATT |
| Nkx2.2 −188 Reverse | ATGCAATTTG TTAAAACGGC TCTTTTCAAG TGTGTGGACT CGAGAGCGAC |
| Nkx2.2 −377 forward | ACGTGTGGGC GGGTCTTGGG AGTCAAGTGG ATGAAGACAG TATTTG |
| Nkx2.2 −377 Reverse | CTGCAAATAC TGTCTTCATC CACTTGACTC CCAAGACCCG CCCAC |
| Nkx2.2 −716 Forward | GTCAATATTT TGGTTGAAGC TTAAGGATGA GTACTAGAAA TGACAAG |
| Nkx2.2 −716 Reverse | TGACTTGTCA TTTCTAGTAC TCATCCTTAA GCTTCAACCA AAATATT |
| Nkx6.2 −1441 Forward | AGCCACTTTA TGGCGGGAAC TGGAAATAAG TGCTGTGGTC CCGCTGACTT CT |
| Nkx6.2 −1441 Reverse | TGCAGAAGTC AGCGGGACCA CAGCACTTAT TTCCAGTTCC CGCCATAAAG TG |
| Nkx6.2 +669 forward | CCGAATCCCG CGCGGGCCAC TTACCGGAGC CGGCCAGTCG CGGGTCCCTC |
| Nkx6.2 +669 reverse | CTGGAGGGAC CCGCGACTGG CCGGCTCCGG TAAGTGGCCC GCGCGGGATT |
| pdx1 −5877 site for | TGCTCATGTG GGCAGAATTA AGTGGAATTA GCTAACAAAT TATATAAAAT |
| Pdx1 −5877 site rev | TGAATTTTAT ATAATTTGTT AGCTAATTCC ACTTAATTCT GCCCACATGA |
| Spock3 −1041 Reverse | GCAACAGGTG TGTCCCGTAT TCTGAGTACT TTGTTCTCAC TCGGGTCATA |
| Spock3 −1044 Forward | AGTTATGACC CGAGTGAGAA CAAAGTACTC AGAATACGGG ACACACCTGT |
| Tm4sf4 −1723 forward | GCCATTAGTG CCAATGACCC AGCACTCGAG GGTAGGGGGA GCACAGC |
| Tm4sf4 −1723 reverse | ACTGGCTGTG CTCCCCCTAC CCTCGAGTGC TGGGTCATTG GCACTAATG |
| Tm4sf4 −5 Forward | CTGAAGGCCT GCCGTAGTTG AGAAGTGAAG TGTCTCCAAG GTTCAAAGAA CT |
| Tm4sf4 −5 Reverse | CAGAGTTCTT TGAACCTTGG AGACACTTCA CTTCTCAACT ACGGCAGGCC TT |
| Tm4sf4 +555 Forward | AGCCCAGAGA ACCAAGCTAA TAGCCACTTG ATTATTTTAC TCTAGTCAAA TTGTG |
| Tm4sf4 +555 Reverse | TGCCACAATT TGACTAGAGT AAAATAATCA AGTGGCTATT AGCTTGGTTC TCTGG |
| Tm4sf4 +912 Forward | CGGCTGTTAG GTCTTGCCTG CCCCACTTAA GCCCCTGAGA CCTGAGGTCT |
| Tm4sf4 +912 Reverse | TGAAGACCTC AGGTCTCAGG GGCTTAAGTG GGGCAGGCAA GACCTAACAG C |

APPENDIX II
Table 2
Checking bound promoter regions from −2500 to +1000 bp.

Gcg (NM_008100) chr2: 62321710 (−) Fold change: e12.5: −19.95
(FDR = 0.00) e13.5: −14.97 (FDR = 0.00)

| | | |
|---|---|---|
| 982 to 995 | ATGCCACTTCATAA | PBM-score: 0.4068 |
| 787 to 800 | AAGGCACTTCAGAA | PBM-score: 0.4205 |
| 271 to 284 | TCTCTAAGTAGTTT | PBM-score: 0.3737 |
| 143 to 156 | ATAGTACTTAAACA | PBM-score: 0.4108 |
| 23 to 36 | ACTTTGAGTGTGTC | PBM-score: 0.3964 |
| −293 to −280 | TCTCTCAAGTGAAT | PBM-score: 0.3994 |
| −445 to −432 | AACCCACTCATCCA | PBM-score: 0.3715 |
| −865 to −852 | ATCATAAGTATGTT | PBM-score: 0.3764 |

Nkx2-2 (NM_001077632) chr2: 147012138 (−) Fold change: e12.5: −4.98
(FDR = 0.00) e13.5: −13.25 (FDR = 0.00)

| | | |
|---|---|---|
| −201 to −188 | GAGTCAAGTGGATG | PBM-score: 0.4350 |
| −390 to −377 | ACACACTTGAAAAG | PBM-score: 0.4255 |
| −729 to −716 | GGATGAGTACTAGA | PBM-score: 0.4072 |
| −1515 to −1502 | CATACCACTTGTTC | PBM-score: 0.3808 |
| −1529 to −1516 | GCCCCACTTAACAT | PBM-score: 0.4148 |

Pyy (NM_145435) chr11: 101969090 (−) Fold change: e12.5: −7.64
(FDR = 0.00) e13.5: −3.01 (FDR = 0.00)
Ghr1 (NM_021488) chr6: 113669874 (−) Fold change: e12.5: 6.48
(FDR = 0.00) e13.5: 6.99 (FDR = 0.00)

| | | |
|---|---|---|
| 124 to 137 | TGACACTTATGAAT | PBM-score: 0.3928 |
| −129 to −116 | ACTAAGTACTCTTT | PBM-score: 0.4308 |

Iapp (NM_010491) chr6: 142246944 (+) Fold change: e12.5: 5.21
(FDR = 0.00) e13.5: 2.12 (FDR = 10.72)

| | | |
|---|---|---|
| −1955 to −1942 | TAGTTAAGTGGTTA | PBM-scorc: 0.4320 |
| −1355 to −1342 | AAGGCACTCAAGAG | PBM-score: 0.4294 |
| −1184 to −1171 | AAAACACTTAAACG | PBM-score: 0.4021 |
| −600 to −587 | AGGCTCTTGAGGGT | PBM-score: 0.3832 |
| 479 to 492 | AACCACTTGAGAGC | PBM-score: 0.4658 |
| 610 to 623 | AGAAGTACTTAAAG | PBM-score: 0.4641 |
| 621 to 634 | AAGCTAAGTGGTTT | PBM-score: 0.3938 |

Tm4sf4 (NM_145539) chr3: 57229380 (+) Fold change: e12.5: 4.52
(FDR = 0.00) e13.5: 3.32 (FDR = 0.00)

| | | |
|---|---|---|
| −1844 to −1831 | ATCTTCAAGAGTTG | PBM-score: 0.3751 |
| −1723 to −1710 | CAGCACTCGAGGGT | PBM-scorc: 0.3895 |
| −1261 to −1248 | TCTCTAAGTGTGTA | PBM-scorc: 0.3722 |
| −5 to 8 | AAGTGAAGTGTCTC | PBM-score: 0.4144 |
| 483 to 496 | TTACTAAGTGGTTC | PBM-score: 0.3914 |
| 555 to 568 | TAGCCACTTGATTA | PBM-score: 0.4276 |
| 912 to 925 | GCCCCACTTAAGCC | PBM-score: 0.3953 |

Tmem27 (NM_020626) chrX: 160528118 (+) Fold change: e12.5: −4.46
(FDR = 0.00) e13.5: −2.80 (FDR = 0.00)

| | | |
|---|---|---|
| 24 to 37 | AGCTTTAAGTAGAG | PBM-score: 0.3738 |
| 708 to 721 | TTCTTAAAGTACAC | PBM-score: 0.3750 |

Chgb (NM_007694) chr2: 132607013 (+) Fold change: e12.5: −2.00
(FDR = 0.35) e13.5: −4.09 (FDR = 0.00)

| | | |
|---|---|---|
| −1529 to −1516 | TCATTGAAGTGTGA | PBM-score: 0.3740 |
| −988 to −975 | GGTAGAGTGCTTTC | PBM-score: 0.3759 |
| −217 to −204 | TTTTGAAGTGTATC | PBM-score: 0.4064 |
| 61 to 74 | TACACACTTCAGAA | PBM-score: 0.3789 |

Smarca4 (NM_011417) chr9: 21420612 (+) Fold change: e12.5: 3.58
(FDR = 0.00) e13.5: 4.07 (FDR = 0.00)

| | | |
|---|---|---|
| −1727 to −1714 | CAAGTGCTCTTAAC | PBM-score: 0.4002 |

Ttr (NM_013697) chr18: 20823913 (+) Fold change: e12.5: −3.61
(FDR = 0.00) e13.5: −2.44 (FDR = 0.00)

| | | |
|---|---|---|
| 174 to 187 | ACTAGAGTACTCAG | PBM-score: 0.4257 |
| 913 to 926 | TCAACACTTATGTT | PBM-score: 0.4159 |

Ins2 (NM_008387) chr7: 149865613 (−) Fold change: e12.5: −1.43
(FDR = 1.54) e13.5: −3.36 (FDR = 0.00)

| | | |
|---|---|---|
| 340 to 353 | TCCTCCACTTCACG | PBM-score: 0.3805 |
| 44 to 57 | GAGAAGAGTACCTT | PBM-score: 0.3766 |
| −477 to −464 | AAGGCACTTAATGG | PBM-score: 0.4156 |
| −702 to −689 | GCTTGGAGTGGTTG | PBM-score: 0.3921 |

Ins1 (NM_008386) chr19: 52338812 (+) Fold change: e12.5: −1.53
(FDR = 0.89) e13.5: −3.26 (FDR = 0.00)

| | | |
|---|---|---|
| −1899 to −1886 | CAAGCACTTTAAAC | PBM-score: 0.4042 |
| −349 to −336 | CCATTAAGTACCTT | PBM-score: 0.4194 |
| −51 to −38 | CAATGAGTGCTTTC | PBM-score: 0.3745 |
| 467 to 480 | CGTGAAGTGGAGGA | PBM-score: 0.3805 |
| 837 to 850 | TAATTCAAGTATCT | PBM-score: 0.4030 |

Slc38a5 (NM_172479) chrX: 7848517 (+) Fold change: e12.5: −3.23
(FDR) = 0.00) e13.5: −3.22 (FDR = 0.00)

| | | |
|---|---|---|
| −1643 to −1630 | AGAAGTACTCTTCA | PBM-score: 0.4387 |
| −1509 to −1496 | AGTGGCACTTCTAT | PBM-score: 0.3921 |
| −1330 to −1317 | ATTTTAAGTACCTA | PBM-score: 0.4269 |
| 81 to 94 | TCCCACTTCAAATG | PBM-score: 0.4017 |

Nepn (NM_025684) chr10: 52111413 (+) Fold change: e12.5: 3.12
(FDR = 0.00) e13.5: 2.00 (FDR = 10.72)
Igfbp3 (NM_008343) chr11: 7113926 (−) Fold change: e12.5: −1.58
(FDR = 0.00) e13.5: −3.07 (FDR = 0.00)

| | | |
|---|---|---|
| −1092 to −1079 | TGGATGAGTGGTGG | PBM-score: 0.3707 |
| −1142 to −1129 | GATACTCTTGAGTT | PBM-score: 0.3802 |
| −1269 to −1256 | TGGTGAAGTGGACA | PBM-score: 0.3737 |

Irf6 (NM_016851 chr1: 194979305 (+) Fold change: el2.5: −1.64
(FDR = 0.00) e13.5: −2.93 (FDR = 0.00)

| | | |
|---|---|---|
| −1335 to −1322 | ATTCAAGAGTGCAC | PBM-score: 0.3950 |
| 334 to 347 | TCTTCAAGTAGTTT | PBM-score: 0.4216 |

Vdac2 (NM_011695) chr14: 22650782 (+) Fold change: e12.5: −2.79
(FDR = 0.00) e13.5: −1.72 (FDR = 12.29)

| | | |
|---|---|---|
| −1520 to −1507 | CAGTACTTGAGTAG | PBM-score: 0.4563 |
| −1358 to −1345 | AGCTGAAGTGTCAG | PBM-score: 0.3801 |
| 870 to 883 | GTTTAAAGTGCCAT | PBM-score: 0.3774 |

Fbxw9 (NM_026791) chr8: 87584017 (+) Fold change: el2.5: −2.77
(FDR = 0.00) e13.5: −1.85 (FDR = 2.56)

| | | |
|---|---|---|
| −1884 to −1871 | CAGTTAAGTGTGCT | PBM-score: 0.3959 |
| −774 to −761 | GAGCACTTTAAGTG | PBM-score: 0.4363 |
| 805 to 818 | CTTACAAGTGTTTG | PBM-score: 0.3868 |

Neurog3 (NM_009719) chrl0: 61595837 (+) Fold change: e12.5: −2.66
(FDR = 0.00) e13.5: −1.80 (FDR = 2.56)

| | | |
|---|---|---|
| −1142 to −1129 | AACCTCTTAAGAGG | PBM-score: 0.4253 |
| −506 to −493 | AAGACACTTGACTC | PBM-score: 0.4165 |

Pla2g1b (NM_011107) chr5: 115916274 (+) Fold change: e12.5: 2.66
(FDR = 0.00) e13.5: 1.85 (FDR = 24.14)

| | | |
|---|---|---|
| −429 to −416 | CAGAGCACTCATAC | PBM-score: 0.3719 |
| 927 to 940 | CTCTGAAGTGTTAG | PBM-score: 0.4065 |

Irx3 (NM_008393) chr8: 94325273 (−) Fold change: r12.5: −1.35
(FDR = 7.71) e13.5: −2.56 (FDR = 0.00)
Gab1 (NM_021356) chr8: 83404378 (−) Fold change: e12.5: −2.52
(FDR = 0.00) e13.5: −2.04 (FDR = 0.00)

| | | |
|---|---|---|
| −1314 to −1301 | CCATAAAGTGCTTT | PBM-score: 0.3757 |
| −1565 to −1552 | ATTTAAAGTGTTGC | PBM-score: 0.3920 |

Myt1 (NM_008665) chf2: 181501746 (+) Fold change: e12.5: −1.32
(FDR = 0.89) e13.5: −2.39 (FDR = 0.00)

| | | |
|---|---|---|
| −650 to −637 | TTTTAAAGTGTTTT | PBM-score: 0.3969 |

Slc7a2 (NM_007514) chr8: 41947720 (+) Fold change: e12.5: −1.39
(FDR = 4.32) e13.5: −2.06 (FDR = 0.00)

| | | |
|---|---|---|
| −1979 to −1966 | TGGAGTACTACTCA | PBM-score: 0.4042 |
| −1854 to −1841 | CTGATAAGTGGATA | PBM-score: 0.4337 |
| 754 to 767 | TAAGCACTTGAGTT | PBM-score: 0.4478 |
| 807 to 820 | GCCTTGAGTACCTT | PBM-score: 0.4056 |

S1c7a2 (NM_001044740) chr8: 41947746 (+) Fold change: e12.5: −1.39
(FDR = 4.32) e13.5: −2.06 (FDR = 0.00)

| | | |
|---|---|---|
| −1880 to −1867 | CTGATAAGTGGATA | PBM-score: 0.4337 |
| 728 to 741 | TAAGCACTTGAGTT | PBM-score: 0.4478 |
| 781 to 794 | GCCTTGAGTACCTT | PBM-score: 0.4056 |

Cox6a1 (NM_007748) chr5: 115798964 (−) Fold change: e12.5: −1.30
(FDR = 19.39) el3.5: −2.00 (FDR = 2.56)
Ela1 (NM_033612) chr15: 100518351 (−) Fold change: e12.5: 1.92
(FDR = 4.32) e13.5: 1.97 (FDR = 11.77)

| | | |
|---|---|---|
| 491 to 504 | GTCTGAAGTGTCTG | PBM-score: 0.4052 |
| 65 to 78 | TGATCCACTTACCA | PBM-score: 0.3875 |
| −195 to −182 | CATCCACTTAACCC | PBM-score: 0.4058 |
| −1249 to −1236 | AACTTGAGTGGCTC | PBM-score: 0.4293 |
| −1625 to −1612 | ATGCACTTGAAAAC | PBM-score: 0.4248 |

Gast (NM_010257) chr11: 100195725 (+) Fold change: e12.5: −1.71
(FDR = 0.00) e13.5: −1.94 (FDR = 0.00)

| | | |
|---|---|---|
| −1993 to −1980 | GCAATTAAGTGGGG | PBM-score: 0.4207 |
| −1145 to −1132 | TATTAGAGTGGTTA | PBM-score: 0.4030 |
| −806 to −793 | TAACCACTTTAAGA | PBM-score: 0.4277 |
| 495 to 508 | AGGAGTACTTATCA | PBM-score: 0.4464 |

Dmwd (NM_010058) chr7: 19661548 (+) Fold change: e12.5: −1.87
(FDR = 0.00) el3.5: −1.71 (FDR = 12.29)

| | | |
|---|---|---|
| −858 to −845 | TCTCCACTCTTACA | PBM-score: 0.3783 |
| −627 to −614 | CTACACTTCACTCT | PBM-score: 0.3885 |

Dsn1 (NM_025853) chr2: 156832811 (−) Fold change: e12.5: 1.87
(FDR = 24.36) e13.5: −1.72 (FDR = 24.14)

| | | |
|---|---|---|
| −380 to −367 | CCCTTAAGTACCTA | PBM-score: 0.4500 |

Disp2 (NM_170593) chr2: 118605653 (+) Fold change: e12.5: −1.38
(FDR = 0.89) e13.5: −1.76 (FDR = 2.56)

| | | |
|---|---|---|
| −713 to −700 | TGCGCACTTAAAAG | PBM-score: 0.3980 |
| 151 to 164 | TCGACACTTGATAA | PBM-score: 0.4159 |
| 799 to 812 | ATGACACTTCATCT | PBM-score: 0.3885 |
| 998 to 1011 | TTATTCAAGAGGGC | PBM-score: 0.3705 |

Crp (NM_007768) chr1: 174628186 (+) Fold change: e12.5: −1.50
(FDR = 0.00) e13.5: −1.68 (FDR = 15.36)

| | | |
|---|---|---|
| −1809 to −1796 | TCTTCTTAAGTGAT | PBM-score: 0.3840 |
| −306 to −293 | ACACAAGTGCTCAT | PBM-score: 0.3856 |
| 573 to 586 | TTTTGGAGTGGGTG | PBM-score: 0.3882 |

Hmgn3 (NM_026122) chr9: 83040132 (−) Fold change: e12.5: −1.21
(FDR = 14.88) e13.5: −1.65 (FDR = 12.29)

| | | |
|---|---|---|
| 136 to 149 | AACACACTCGAGGG | PBM-score: 0.3803 |
| −217 to −204 | TTTCCACTTCACTG | PBM-score: 0.3928 |
| −1941 to −1928 | ATGGTACTTGAGGT | PBM-score: 0.4237 |

Hmgn3 (NM_175074) chr9: 83040212 (−) Fold change: e12.5: −1.21
(FDR = 14.88) e13.5: −1.65 (FDR = 12.29)

| | | |
|---|---|---|
| 216 to 229 | AACACACTCGAGGG | PBM-score: 0.3803 |
| −137 to −124 | TTTCCACTTCACTG | PBM-score: 0.3928 |
| −1861 to −1848 | ATGGTACTTGAGGT | PBM-score: 0.4237 |

Rdh16 (NM_009040) chr10: 127238208 (+) Fold change: e12.5: −1.51
(FDR = 0.35) e13.5: −1.59 (FDR = 19.07)

| | | |
|---|---|---|
| −1376 to −1363 | AACAAGAGTGTCCA | PBM-score: 0.3777 |
| −571 to −558 | GGCCACTTGAGATC | PBM-score: 0.4434 |

Spock3 (NM_023689) chr8: 65430243 (+) Fold change: e12.5: NA
(FDR = NA) e13.5: 2.3 (FDR = 1.0)

| | | |
|---|---|---|
| −1516 to −1503 | TTTTTGAAGTAGAG | PBM-score: 0.3767 |
| −1057 to −1044 | CAAAGTACTCAGAA | PBM-score: 0.3905 |

Nkx6-2 (NM_183248) chr7: 146768692 (−) Fold change: e12.5: NA
FDR = NA) el3.5: 8.3 (FDR = 0.0)

| | | |
|---|---|---|
| −1431 to −1418 | AAGCCACTTTATGG | PBM-score: 0.3850 |
| −1454 to −1441 | GAAATAAGTGCTGT | PBM-score: 0.3912 |

Irs4 (NM_010572) chrX: 138159760 (−) Fold change: e12.5: NA
(FDR = NA) e13.5: 4.9 (FDR = 0.0)

| | | |
|---|---|---|
| −124 to −111 | CGCCCACTTCACTG | PBM-score: 0.3953 |

Frzb (NM_011356) chr2: 80287553 (−) Fold change: e12.5: NA
(FDR = NA) e13.5: 3.2 (FDR = 19.3)

| | | |
|---|---|---|
| 922 to 935 | CGGTACTTGATGAG | PBM-score: 0.4107 |
| −693 to −680 | AGCCCACTTTAAAG | PBM-score: 0.3983 |
| −1625 to −1612 | GAACTCAAGAGGTT | PBM-score: 0.3961 |

APPENDIX III
Table 3:

| Primer | Sequence |
|---|---|
| Chgb −217 For | CACCAATTATGTGTGCTCCAA |
| Chgb −217 Rev | GGAATCTCCTACCCGACGTA |
| Chgb −1529 For | GGGAACAAACACAGGGTGAC |
| Chgb −1529 Rev | TCACTACCCTATTCCCATTTTCA |
| Frzb −2290 For | TCCGAATTTTGGGTTTGTTG |
| Frzb −2290 Rev | AAAACTGGCTGGTGGAAATG |
| Gcg −280/−432 For | TCTCCCCACAAAGAGAATACAAA |
| Gcg −280/−432 Rev | CCCTTGATTTGGTATTTGGC |
| Gcg −1080 For | GTAGCTCCACACCCACCAGT |
| Gcg −1080 Rev | TGACAAGACCACAGCGTTTC |
| Iapp −1955 For | CCAGTGGTTAAGCTGGTATGG |
| Iapp −1955 Rev | TATTGCAAATGCCACTCCTG |
| Iapp −1184/−1355 For | GAGAAGCTGAAAATCGACGC |
| Iapp −1184/−1355 Rev | GGCCTCCAGTCTCTTGAGTG |
| Iapp +479 For | CAGCTGTCCTCCTCATCCTC |
| Iapp +479 Rev | TCTCATAGCCAGGATTTGCTT |
| Irs4 −111 For | GACGGTCACGTGTTGTTTTG |
| Irs4 −111 Rev | GATGCACCGTGGTTTTAAGG |
| Ngn3 −506 For | GGTTGCACACACATTTCCTG |
| Ngn3 −506 Rev | TCTTTTGGCTCAGAGAGGGA |
| Nkx2-2 −188/−377 For | CGGCTCTTTTCAAGTGTGTG |
| Nkx2-2 −188/−377 Rev | GTGAAATTGTGGGTTTTGGG |
| Nkx2-2 −716 For | CTGGCATGTCCAAGCCTATT |
| Nkx2-2 −716 Rev | GCTGGTGGTTCCCTAAACAA |
| Nkx2-2 −1502/−1516 For | GGACTAAGGCAACCCAAACA |
| Nkx2-2 −1502/−1516 Rev | GAGGTACGAGGCTGCAAGTT |
| Pdx1 −5877 For | CAAGCACACAGTAGGTGTTCTC |
| Pdx1 −5877 Rev | TGCCTCTGACTGTGTCCCACT |
| Spock3 −1044 For | ATCATCTAAAAGTTATGACCCGAG |
| Spock3 −1044 Rev | TGAATTACATATGTCAGGCAAGC |
| Tm4sf4 −1723 For | GGGAGATGATGCAGTGGGTACG |
| Tm4sf4 −1723 Rev | TTCAGGGGCAGTCACACTTAGAC |
| Tm4sf4 −5 For | GGCCTGCCGTACTTGAGAAG |
| Tm4sf4 −5 Rev | CACAGGAAAGCACAGAGATCAAAGG |
| Tm4sf4 +483/+555 For | CCCTTTCTATTCGCGGCTGG |
| Tm4sf4 +483/+555 Rev | CTTACAGCTTCTGTGTCCCTTCAT |
| Mafa For | CACCCCAGCGAGGGCTGATTTAATT |
| Mafa Rev | AGCAAGCACTTCAGTGTGCTCAGTG |
| GapdH For | CGCATCTTCTTGTGCAGTGCCAG |
| GapdH Rev | TACGGGACGAGGCTGCAGGAG |

What is claimed is:

1. A system for identifying transcription factor binding sites, comprising:
at least one hardware processor that:
receives chromosome sequence data;
selects a first plurality of overlapping octamers from the chromosome sequence data;
assigns an enrichment score to each of the first plurality of overlapping octamers to produce a first set of enrichment scores;
calculates a first average of the first set of enrichment scores;
determines whether the first average is above a threshold;
selects a second plurality of overlapping octamers from the chromosome sequence data;
assigns an enrichment score to each of the second plurality of overlapping octamers to produce a second set of enrichment scores;
calculates a second average of the second set of enrichment scores;
determines whether the second average is above the threshold; and
outputs data that indicates that a transcription factor binding site has been identified in connection with at least one of the first plurality of octamers and the second plurality of octamers.

2. The system of claim 1, wherein the first plurality of overlapping octamers and the second plurality of overlapping octamers each consist of seven octamers.

3. The system of claim 1, wherein the first plurality of overlapping octamers and the second plurality of overlapping octamers each consist of five octamers.

4. The system of claim 1, wherein the enrichment scores are based on protein binding microarray data.

5. The system of claim 1, where in the threshold is approximately 0.37.

6. The system of claim 1, wherein the transcription factor binding site is an Nkx2.2 transcription factor binding site.

7. A method for identifying transcription factor binding sites, comprising:
receiving chromosome sequence data;
selecting a first plurality of overlapping octamers from the chromosome sequence data;
assigning an e-score to each of the first plurality of overlapping octamers to produce a first set of e-scores;
calculating a first average of the first set of e-scores;
determining whether the first average is above a threshold;
selecting a second plurality of overlapping octamers from the chromosome sequence data;
assigning an e-score to each of the second plurality of overlapping octamers to produce a second set of e-scores;
calculating a second average of the second set of e-scores;
determining whether the second average is above the threshold; and
outputting data that indicates that a transcription factor binding site has been identified in connection with at least one of the first plurality of octamers and the second plurality of octamers.

8. The method of claim 7, wherein the first plurality of overlapping octamers and the second plurality of overlapping octamers each consist of seven octamers.

9. The method of claim 7, wherein the first plurality of overlapping octamers and the second plurality of overlapping octamers each consist of five octamers.

10. The method of claim 7, wherein the enrichment scores are based on protein binding microarray data.

11. The method of claim 7, where in the threshold is approximately 0.37.

12. The method of claim 7, wherein the transcription factor binding site is an Nkx2.2 transcription factor binding site.

13. A non-transitory computer readable medium containing computer-executable instructions that, when executed by a processor, cause the processor to perform a method for identifying transcription factor binding sites, comprising:
receiving chromosome sequence data;
selecting a first plurality of overlapping octamers from the chromosome sequence data;
assigning an e-score to each of the first plurality of overlapping octamers to produce a first set of e-scores;
calculating a first average of the first set of e-scores; determining whether the first average is above a threshold;
selecting a second plurality of overlapping octamers from the chromosome sequence data;
assigning an e-score to each of the second plurality of overlapping octamers to produce a second set of e-scores;
calculating a second average of the second set of e-scores;
determining whether the second average is above the threshold; and
outputting data that indicates that a transcription factor binding site has been identified in connection with at least one of the first plurality of octamers and the second plurality of octamers.

14. The non-transitory computer readable medium of claim 13, wherein the first plurality of overlapping octamers and the second plurality of overlapping octamers each consist of seven octamers.

15. The non-transitory computer readable medium of claim 13, wherein the first plurality of overlapping octamers and the second plurality of overlapping octamers each consist of five octamers.

16. The non-transitory computer readable medium of claim 13, wherein the enrichment scores are based on protein binding microarray data.

17. The non-transitory computer readable medium of claim 13, where in the threshold is approximately 0.37.

18. The non-transitory computer readable medium of claim 13, wherein the transcription factor binding site is an Nkx2.2 transcription factor binding site.


SEQUENCE LISTING (96 sequences)

SEQ ID NO: 1 - DNA, 50 bp, Artificial Sequence
  Chgb -1529 Forward
gaacaaacacagggtgactcattgaagtgtgatgcatggctaaaagcaga

SEQ ID NO: 2 - DNA, 50 bp, Artificial Sequence
  Chgb -1529 Reverse
agttctgcttttagccatgcatcacacttcaatgagtcaccctgtgtttg

SEQ ID NO: 3 - DNA, 43 bp, Artificial Sequence
  Chgb -217 Forward
tgaggttaaaagagagagagaattttgaagtgtatcctttggc

SEQ ID NO: 4 - DNA, 42 bp, Artificial Sequence
  Chgb -217 Reverse
aggccaaaggatacacttcaaaattctctctctcttttaacc

SEQ ID NO: 5 - DNA, 48 bp, Artificial Sequence
  Frzb -2290 Forward
agtccaaatatcttaaggagataaaccacttgagaggagacttaattc

SEQ ID NO: 6 - DNA, 49 bp, Artificial Sequence
  Frzb -2290 Reverse
ttgagaattaagtctcctctcaagtggtttatctccttaagatatttgg

SEQ ID NO: 7 - DNA, 50 bp, Artificial Sequence
  Gcg -1080 Forward
agaccattgaaacaactggaggagtactctgactgaacttaattcttcat

SEQ ID NO: 8 - DNA, 50 bp, Artificial Sequence
  Gcg -1080 Reverse
agaatgaagaattaagttcagtcagagtactcctccagttgtttcaatgg

SEQ ID NO: 9 - DNA, 53 bp, Artificial Sequence
  Gcg -280 Forward
acgaaaaactgctaaagttctctcaagtgaattttgacgtcaaatgagcctag

SEQ ID NO: 10 - DNA, 53 bp, Artificial Sequence
  Gcg -280 Reverse
agactaggctcatttgacgtcaaaattcacttgagagaactttagcagttttt

SEQ ID NO: 11 - DNA, 54 bp, Artificial Sequence
  Gcg -432 Forward
agtacacacatatcaataacccactcatccacattgtatggaataaatttgtat

SEQ ID NO: 12 - DNA, 54 bp, Artificial Sequence
  Gcg -432 Reverse
agaatacaaatttattccatacaatgtggatgagtgggttattgatatgtgtgt

SEQ ID NO: 13 - DNA, 50 bp, Artificial Sequence
  Iapp -1184 Forward
agtgtaaaaaataaattaattttaaaaaaaacacttaaacgtgaacacat

SEQ ID NO: 14 - DNA, 50 bp, Artificial Sequence
  Iapp -1184 Reverse
tgtatgtgttcacgtttaagtgttttttttaaaattaatttattttttac

SEQ ID NO: 15 - DNA, 60 bp, Artificial Sequence
  Iapp -1355 Forward
tgtcctcaggccgctacataaaggcactcaagagactggaggccccagggagtttggagg

SEQ ID NO: 16 - DNA, 60 bp, Artificial Sequence
  Iapp -1355 Reverse
tgacctccaaactccctggggcctccagtctcttgagtgcctttatgtagcggcctgagg

SEQ ID NO: 17 - DNA, 49 bp, Artificial Sequence
  Iapp -1955 Forward
gttaagctggtatggctagttaagtggttatagctgacatataatgtct

SEQ ID NO: 18 - DNA, 49 bp, Artificial Sequence
  Iapp -1955 Reverse
tgaagacattatatgtcagctataaccacttaactagccataccagctt

SEQ ID NO: 19 - DNA, 50 bp, Artificial Sequence
  Iapp +479 Forward
tgtcctcctcatcctctctgtggcactgaaccacttgagagctacacctg

SEQ ID NO: 20 - DNA, 50 bp, Artificial Sequence
  Iapp +479 Reverse
tgacaggtgtagctctcaagtggttcagtgccacagagaggatgaggagg

SEQ ID NO: 21 - DNA, 47 bp, Artificial Sequence
  Ins -144 Forward
tgctttctgcagacctagcaccaggcaagtgtttggaaactgcagct

SEQ ID NO: 22 - DNA, 47 bp, Artificial Sequence
  Ins -144 Reverse
ctgaagctgcagtttccaaacacttgcctggtgctaggtctgcagaa

SEQ ID NO: 23 - DNA, 48 bp, Artificial Sequence
  Ins -471 Forward
aagcagaactcaggcagcaaggtacttaatggtccctccttctccatc

SEQ ID NO: 24 - DNA, 47 bp, Artificial Sequence
  Ins -471 Reverse
agagatggagaaggagggaccattaagtaccttgctgcctgagttct

SEQ ID NO: 25 - DNA, 48 bp, Artificial Sequence
  Irs4 -111 Forward
ccgcctaggcccgcgtccccgcccacttcactgggctcaaggcagtgg

SEQ ID NO: 26 - DNA, 48 bp, Artificial Sequence
  Irs4 -111 Reverse
tgcccactgccttgagcccagtgaagtgggcggggacgcgggcctagg

SEQ ID NO: 27 - DNA, 53 bp, Artificial Sequence
  Irs4 +1495 Forward
agccctggctactggaaccttggccacttgagccccgtccacctcctgagccc

SEQ ID NO: 28 - DNA, 53 bp, Artificial Sequence
  Irs4 +1495 Reverse
ccggggctcaggaggtggacggggctcaagtggccaaggttccagtagccagg

SEQ ID NO: 29 - DNA, 50 bp, Artificial Sequence
  Mafa Forward
tgtaaccaggaggcagcccctccagcaagcacttcagtgtgctcagtggg

SEQ ID NO: 30 - DNA, 51 bp, Artificial Sequence
  Mafa Reverse
aacagccccactgagcacactgaagtgcttgctggaggggctgcctcctgg

SEQ ID NO: 31 - DNA, 51 bp, Artificial Sequence
  Ngn3 -506 Forward
cgctcctcccagctgccagccaagaagacacttgactccttgatcgctggt

SEQ ID NO: 32 - DNA, 51 bp, Artificial Sequence
  Ngn3 -506 Reverse
tgaaccagcgatcaaggagtcaagtgtcttcttggctggcagctgggagga

SEQ ID NO: 33 - DNA, 56 bp, Artificial Sequence
  Nkx2.2 -1502 Forward
gctgcaagtttgctacataccacttgttcgccccacttaacatcaggagtgggctt

SEQ ID NO: 34 - DNA, 56 bp, Artificial Sequence
  Nkx2.2 -1502 Reverse
gctaagcccactcctgatgttaagtggggcgaacaagtggtatgtagcaaacttgc

SEQ ID NO: 35 - DNA, 49 bp, Artificial Sequence
  Nkx2.2 -188 Forward
cgcgtcgctctcgagtccacacacttgaaaagagccgttttaacaaatt

SEQ ID NO: 36 - DNA, 50 bp, Artificial Sequence
  Nkx2.2 -188 Reverse
atgcaatttgttaaaacggctcttttcaagtgtgtggactcgagagcgac

SEQ ID NO: 37 - DNA, 46 bp, Artificial Sequence
  Nkx2.2 -377 Forward
acgtgtgggcgggtcttgggagtcaagtggatgaagacagtatttg

SEQ ID NO: 38 - DNA, 45 bp, Artificial Sequence
  Nkx2.2 -377 Reverse
ctgcaaatactgtcttcatccacttgactcccaagacccgcccac

SEQ ID NO: 39 - DNA, 47 bp, Artificial Sequence
  Nkx2.2 -716 Forward
gtcaatattttggttgaagcttaaggatgagtactagaaatgacaag

SEQ ID NO: 40 - DNA, 47 bp, Artificial Sequence
  Nkx2.2 -716 Reverse
tgacttgtcatttctagtactcatccttaagcttcaaccaaaatatt

SEQ ID NO: 41 - DNA, 52 bp, Artificial Sequence
  Nkx6.2 -1441 Forward
agccactttatggcgggaactggaaataagtgctgtggtcccgctgacttct

SEQ ID NO: 42 - DNA, 52 bp, Artificial Sequence
  Nkx6.2 -1441 Reverse
tgcagaagtcagcgggaccacagcacttatttccagttcccgccataaagtg

SEQ ID NO: 43 - DNA, 50 bp, Artificial Sequence
  Nkx6.2 +669 Forward
ccgaatcccgcgcgggccacttaccggagccggccagtcgcgggtccctc

SEQ ID NO: 44 - DNA, 50 bp, Artificial Sequence
  Nkx6.2 +669 Reverse
ctggagggacccgcgactggccggctccggtaagtggcccgcgcgggatt

SEQ ID NO: 45 - DNA, 50 bp, Artificial Sequence
  Pdx1 -5877 Site For
tgctcatgtgggcagaattaagtggaattagctaacaaattatataaaat

SEQ ID NO: 46 - DNA, 50 bp, Artificial Sequence
  Pdx1 -5877 Site Rev
tgaattttatataatttgttagctaattccacttaattctgcccacatga

SEQ ID NO: 47 - DNA, 50 bp, Artificial Sequence
  Spock3 -1041 Reverse
gcaacaggtgtgtcccgtattctgagtactttgttctcactcgggtcata

SEQ ID NO: 48 - DNA, 50 bp, Artificial Sequence
  Spock3 -1044 Forward
agttatgacccgagtgagaacaaagtactcagaatacgggacacacctgt

SEQ ID NO: 49 - DNA, 47 bp, Artificial Sequence
  Tm4sf4 -1723 Forward
gccattagtgccaatgacccagcactcgagggtagggggagcacagc

SEQ ID NO: 50 - DNA, 49 bp, Artificial Sequence
  Tm4sf4 -1723 Reverse
actggctgtgctccccctaccctcgagtgctgggtcattggcactaatg

SEQ ID NO: 51 - DNA, 52 bp, Artificial Sequence
  Tm4sf4 -5 Forward
ctgaaggcctgccgtagttgagaagtgaagtgtctccaaggttcaaagaact

SEQ ID NO: 52 - DNA, 52 bp, Artificial Sequence
  Tm4sf4 -5 Reverse
cagagttctttgaaccttggagacacttcacttctcaactacggcaggcctt

SEQ ID NO: 53 - DNA, 55 bp, Artificial Sequence
  Tm4sf4 +555 Forward
agcccagagaaccaagctaatagccacttgattattttactctagtcaaattgtg

SEQ ID NO: 54 - DNA, 55 bp, Artificial Sequence
  Tm4sf4 +555 Reverse
tgccacaatttgactagagtaaaataatcaagtggctattagcttggttctctgg

SEQ ID NO: 55 - DNA, 50 bp, Artificial Sequence
  Tm4sf4 +912 Forward
cggctgttaggtcttgcctgccccacttaagcccctgagacctgaggtct

SEQ ID NO: 56 - DNA, 51 bp, Artificial Sequence
  Tm4sf4 +912 Reverse
tgaagacctcaggtctcaggggcttaagtggggcaggcaagacctaacagc

SEQ ID NO: 57 - DNA, 21 bp, Artificial Sequence
  Chgb -217 For
caccaattatgtgtgctccaa

SEQ ID NO: 58 - DNA, 20 bp, Artificial Sequence
  Chgb -217 Rev
ggaatctcctacccgacgta

SEQ ID NO: 59 - DNA, 20 bp, Artificial Sequence
  Chgb -1529 For
gggaacaaacacagggtgac

SEQ ID NO: 60 - DNA, 23 bp, Artificial Sequence
  Chgb -1529 Rev
tcactaccctattcccattttca

SEQ ID NO: 61 - DNA, 20 bp, Artificial Sequence
  Frzb -2290 For
tccgaattttgggtttgttg

SEQ ID NO: 62 - DNA, 20 bp, Artificial Sequence
  Frzb -2290 Rev
aaaactggctggtggaaatg

SEQ ID NO: 63 - DNA, 23 bp, Artificial Sequence
  Gcg -280/-432 For
tctccccacaaagagaatacaaa

SEQ ID NO: 64 - DNA, 20 bp, Artificial Sequence
  Gcg -280/-432  Rev
cccttgatttggtatttggc

SEQ ID NO: 65 - DNA, 20 bp, Artificial Sequence
  Gcg -1080 For
gtagctccacacccaccagt

SEQ ID NO: 66 - DNA, 20 bp, Artificial Sequence
  Gcg -1080 Rev
tgacaagaccacagcgtttc

SEQ ID NO: 67 - DNA, 21 bp, Artificial Sequence
  Iapp -1955 For
ccagtggttaagctggtatgg

SEQ ID NO: 68 - DNA, 20 bp, Artificial Sequence
  Iapp -1955 Rev
tattgcaaatgccactcctg

SEQ ID NO: 69 - DNA, 20 bp, Artificial Sequence
  Iapp -1184/-1355 For
gagaagctgaaaatcgacgc

SEQ ID NO: 70 - DNA, 20 bp, Artificial Sequence
  Iapp -1184/-1355 Rev
ggcctccagtctcttgagtg

SEQ ID NO: 71 - DNA, 20 bp, Artificial Sequence
  Iapp +479 For
cagctgtcctcctcatcctc

SEQ ID NO: 72 - DNA, 21 bp, Artificial Sequence
  Iapp +479 Rev
tctcatagccaggatttgctt

SEQ ID NO: 73 - DNA, 20 bp, Artificial Sequence
  Irs4 -111 For
gacggtcacgtgttgttttg

SEQ ID NO: 74 - DNA, 20 bp, Artificial Sequence
  Irs4 -111 Rev
gatgcaccgtggttttaagg

SEQ ID NO: 75 - DNA, 20 bp, Artificial Sequence
  Ngn3 -506 For
ggttgcacacacatttcctg

SEQ ID NO: 76 - DNA, 20 bp, Artificial Sequence
  Ngn3 -506 Rev
tcttttggctcagagaggga

SEQ ID NO: 77 - DNA, 20 bp, Artificial Sequence
  Nkx2-2 -188/-377 For
cggctcttttcaagtgtgtg

SEQ ID NO: 78 - DNA, 20 bp, Artificial Sequence
  Nkx2-2 -188/-377 Rev
gtgaaattgtgggttttggg

SEQ ID NO: 79 - DNA, 20 bp, Artificial Sequence
  Nkx2-2 -716 For
ctggcatgtccaagcctatt

SEQ ID NO: 80 - DNA, 20 bp, Artificial Sequence
  Nkx2-2 -716 Rev
gctggtggttccctaaacaa

SEQ ID NO: 81 - DNA, 20 bp, Artificial Sequence
  Nkx2-2 -1502/-1516 For
ggactaaggcaacccaaaca

SEQ ID NO: 82 - DNA, 20 bp, Artificial Sequence
  Nkx2-2 -1502/-1516 Rev
gaggtacgaggctgcaagtt

SEQ ID NO: 83 - DNA, 22 bp, Artificial Sequence
  Pdx1 -5877 For
caagcacacagtaggtgttctc

SEQ ID NO: 84 - DNA, 21 bp, Artificial Sequence
  Pdx1 -5877 Rev
tgcctctgactgtgtcccact

SEQ ID NO: 85 - DNA, 24 bp, Artificial Sequence
  Spock3 -1044 For
atcatctaaaagttatgacccgag

SEQ ID NO: 86 - DNA, 23 bp, Artificial Sequence
  Spock3 -1044 Rev
tgaattacatatgtcaggcaagc

SEQ ID NO: 87 - DNA, 22 bp, Artificial Sequence
  Tm4sf4 -1723 For
gggagatgatgcagtgggtacg

SEQ ID NO: 88 - DNA, 23 bp, Artificial Sequence
  Tm4sf4 -1723 Rev
ttcaggggcagtcacacttagac

SEQ ID NO: 89 - DNA, 20 bp, Artificial Sequence
  Tm4sf4 -5 For
ggcctgccgtacttgagaag

SEQ ID NO: 90 - DNA, 25 bp, Artificial Sequence
  Tm4sf4 -5 Rev
cacaggaaagcacagagatcaaagg

SEQ ID NO: 91 - DNA, 20 bp, Artificial Sequence
  Tm4sf4 +483/+555 For
ccctttctattcgcggctgg

SEQ ID NO: 92 - DNA, 24 bp, Artificial Sequence
  Tm4sf4 +483/+555 Rev
cttacagcttctgtgtcccttcat

SEQ ID NO: 93 - DNA, 25 bp, Artificial Sequence
  Mafa For
caccccagcgagggctgatttaatt

SEQ ID NO: 94 - DNA, 25 bp, Artificial Sequence
  Mafa Rev
agcaagcacttcagtgtgctcagtg

SEQ ID NO: 95 - DNA, 23 bp, Artificial Sequence
  GapdH For
cgcatcttcttgtgcagtgccag

SEQ ID NO: 96 - DNA, 21 bp, Artificial Sequence
  GapdH Rev
tacgggacgaggctgcaggag